(19) United States
(12) Patent Application Publication
(10) Pub. No.: US 2025/0307736 A1
(43) Pub. Date: Oct. 2, 2025

(54) SYSTEM AND METHOD FOR OPTIMIZING STAFFING OF A WORKING-SHIFT DURING A DATE RANGE BY PREDICTING ADHERENCE PARAMETER OF THE WORKING-SHIFT BASED ON A SCHEDULING UNIT

(71) Applicant: NICE LTD., Ra'anana (IL)

(72) Inventors: Disha AGRAWAL, Pune (IN); Rhea MADHUSUTHAN, Pune (IN)

(21) Appl. No.: 18/619,269

(22) Filed: Mar. 28, 2024

(51) Int. Cl. G06Q 10/0631; G06Q 10/1093

(52) U.S. Cl. CPC G06Q 10/063116; G06Q 10/1097

(57) ABSTRACT

A computerized-method for optimizing staffing of working-shifts during a date-range by predicting adherence parameter of the working-shift based on an SU. The computerized-method includes: (i) configuring, a UI of a WFM application, to receive: a. date-range; b. SU; and c. activity code for the working-shifts, for the staffing. For each interval-time in each working-shift (ii) operating a forecast-adherence engine to yield the predicted adherence parameter; (iii) operating a coaching-aggregation engine to yield a coaching parameter; (iv) operating a time-off aggregation engine to yield a time-off parameter; (v) operating a shrinkage-calculator based on the predicted adherence parameter, the aggregated coaching parameter, and the aggregated time-off parameter, to yield a shrinkage parameter; (vi) configuring the WFM to automatically schedule staffing for the interval-time based on the yielded shrinkage parameter; (vii) storing the working-shift in a database and configuring the WFM application to automatically trigger a notification to each agent scheduled the working-shift.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of data analysis, and more specifically to optimizing staffing of a working-shift during a date range by predicting adherence parameter of the working-shift based on a Scheduling Unit (SU).

### BACKGROUND

There are multiple processes involved in workforce management of a contact center like forecasting, staffing, scheduling, adherence, and intraday management. Forecasting and staffing are first step to estimate the volume of expected interaction and predict the agents required to handle the same. Next step is scheduling, which involving planning for agents' time to handle the call interaction. Last is adherence and intraday management to keep track of agents' activity and deviation from the forecast.

Adherence metric in contact centers indicates deviation of an agent from the scheduled activity. If the agent is not performing as per the schedule that has been assigned to the agent during staffing plans process, it is considered as out of adherence. This agent adherence metric is used to track the agent performance and efficiency of the contact center during the peak times of interactions.

Current Workforce Management (WFM) systems calculate agents adherence to their schedule only in real-time or after the agents have performed the activity. However, when out of adherence scenarios are considered only after they have occurred, it may result in a high Average Speed of Answer (ASA) and bad customer experience. There is currently no existing technical solution to improve staffing plans by using an adherence parameter.

Shrinkage indicates the time duration for which agent is paid to work, however the agent is not available to due to sick time, late time, meetings, training, and other unaccounted reasons. This shrinkage factor is used in the staffing process to compensate for the unavailability of certain agents. In other words, shrinkage is the amount of “over-scheduling” that is needed to ensure that there is the right number of agents working at any given time of the day to meet the organization business goals.

In current WFM systems, the shrinkage parameter that is used in the staffing calculations, is entered manually, which leads to errors and low accuracy of the generated staffing plans. Moreover, in current WFM systems, the shrinkage parameter that is used during the staffing process, considers absence or trainings, but not the adherence factor.

The shrinkage parameter is entered manually for many Scheduling Units (SU) s and the manual process may be an exhausting experience for the users. Therefore, there is a need for a technical solution for optimizing staffing of a working-shift during a date range by predicting adherence parameter of the working-shift based on a Scheduling Unit (SU). There is also a need for a technical solution to provide a time-slot to schedule an activity such that maximum adherence is achieved.

Current Workforce Management (WFM) systems calculate agents adherence to schedule in real-time or after the agents have performed the activity, but not beforehand. When out of adherence scenarios are known after they happen, it may result in high Average Speed of Answer (ASA) and bad customer experience.

Optimization of staffing plans may be achieved by reducing overstaffing and understaffing therein. Currently, there is no technical solution to improve or optimize staffing plans by using an adherence parameter such that the schedules in the staffing plans are adjusted in advance to achieve maximum adherence. In current WFM systems, the shrinkage parameter that is used in the staffing calculations is entered manually which is leading to errors and low accuracy of the generated staffing plans.

Furthermore, in current WFM systems, the shrinkage parameter during staffing process, considers absence or trainings, but not the adherence factor. The shrinkage parameter is entered manually for many Scheduling Units (SU) s based on past experience and when an SU is for example, 15 min, it may lead to lengthy calculations. Thus, the manual process results in a bad experience for the users of the WFM system.

Accordingly, there is a need for a technical solution for calculating the shrinkage parameter by using data that is present in the system and adherence parameter. There is also a need for a technical solution to provide a time-slot to schedule an activity, such that maximum adherence to schedule is achieved.

### SUMMARY

There is thus provided, in accordance with some embodiments of the present disclosure, a computerized-method for optimizing staffing of one or more working-shifts during a date range by predicting adherence parameter of the working-shift based on a Scheduling Unit (SU).

Furthermore, in accordance with some embodiments of the present disclosure, the computerized-method may include: (i) configuring, by one or more processors, a User Interface (UI) that is associated to a Workforce Management (WFM) application, to receive: a. date range; b. SU; and c. activity code for the working-shifts, for the staffing. There are one or more working-shifts during the date range. For each interval-time in each working-shift in the one or more working-shifts: (ii) operating by the one or more processors, a forecast adherence engine to yield the predicted adherence parameter; (iii) operating by the one or more processors a coaching aggregation engine to yield a coaching parameter; (iv) operating by the one or more processors a time-off aggregation engine to yield a time-off parameter; (v) operating by the one or more processors a shrinkage calculator based on the predicted adherence parameter, the aggregated coaching parameter, and the aggregated time-off parameter, to yield a shrinkage parameter; (vi) configuring by the one or more processors the WFM to automatically schedule staffing for the interval-time based on the yielded shrinkage parameter; and (vii) after all time-intervals in each working-shift has been scheduled staffing, storing the working-shift in a database that is associated to the WFM application and configuring the WFM application to automatically trigger a notification to each agent that has been scheduled the working-shift.

Furthermore, in accordance with some embodiments of the present disclosure, the forecast adherence engine may include: (i) retrieving from the database historic working-shifts during a preconfigured period for the SU and the activity code; (ii) aggregating adherence data of each historic interval-time in the retrieved historic working-shifts; (iii) calculating an average of adherence percentage of each historic time-interval to yield an actual adherence percentage; (iv) applying a plurality of statistical algorithms on each historic interval-time in the retrieved working-shifts to yield a predicted history-adherence parameter; (v) calculating a Mean Absolute Percentage Error (MAPE) for each statistical algorithm; (vi) selecting a statistical algorithm from the plurality of statistical algorithms based on the calculated MAPE; and (vii) applying the selected statistical algorithm on the interval-time to yield the predicted adherence parameter.

Furthermore, in accordance with some embodiments of the present disclosure, the plurality of statistical algorithms comprising at least one of: (i) Box Jenkins Arima model; (ii) Exponential smoothing model; and (iii) Curve fitting model.

Furthermore, in accordance with some embodiments of the present disclosure, the coaching aggregation engine may include: (i) retrieving from the database coaching data that is related to the SU for the interval-time; and (ii) calculating the average of coaching time during the interval-time to yield the coaching parameter. The calculating of the average of coaching time during the interval-time is according to formula I:

average of coaching time=total coaching duration*100/total duration, (I)
whereby:
total coaching duration is a sum of coaching duration during the interval-time of each agent that is related to the received SU, and
total duration is the number of agents that relate to the SU in the interval-time.

Furthermore, in accordance with some embodiments of the present disclosure, the time-off aggregation engine may include: (i) retrieving from the database time-off data that is related to the SU for the interval-time; and (ii) calculating the average of time-off during the interval-time to yield the time-off parameter. The calculating of the average time-off during the interval-time is according to formula II:

average time-off=total time-off duration*100/total duration, (II)
whereby:
the total time-off duration is a sum of time-off duration during the interval-time of each agent that is related to the received SU, and
the total duration is the number of agents that relate to the SU in the interval-time.

Furthermore, in accordance with some embodiments of the present disclosure, the shrinkage calculator may include: (i) calculating a total duration of the interval-time by multiplying duration of the interval-time by a number of agents in the SU; and (ii) calculating the shrinkage parameter according to formula III:

shrinkage parameter=(W1*predicted adherence parameter+W2*coaching parameter+W3*time-off parameter)/total duration*100, (III)
whereby:
the total duration is the calculated total duration,
the predicted adherence parameter is the yielded predicted adherence parameter,
the coaching parameter is the yielded coaching parameter,
the time-off parameter is the yielded time-off parameter, and
the W1, W2, W3 are weights ranging from ‘0’ to ‘1’ and a sum of all weights is ‘1’.

Furthermore, in accordance with some embodiments of the present disclosure, the computerized-method may further include configuring the UI that is associated the WFM application to receive the weights.

Furthermore, in accordance with some embodiments of the present disclosure, the SU may include a group of agents. For example, the SU may include agents from the sales unit or agents from marketing unit.

Furthermore, in accordance with some embodiments of the present disclosure, in a computerized system for optimizing staffing of one or more working-shifts during a date range by predicting adherence parameter of the working-shift based on a Scheduling Unit (SU) that includes a database, a memory to store the database and one or more processors, the one or more processors may be configured to: (i) configure a User Interface (UI) that is associated to a Workforce Management (WFM) application to receive: a. date range; b. SU; and c. activity code for the working-shifts, for the staffing. There are one or more working-shifts during the date range. For each interval-time in each working-shift in the one or more working-shifts: (i) operate a forecast adherence engine to yield the predicted adherence parameter; (ii) operate a coaching aggregation engine to yield a coaching parameter; (iii) operate a time-off aggregation engine to yield a time-off parameter; (iv) operate a shrinkage calculator based on the predicted adherence parameter, the aggregated coaching parameter, and the aggregated time-off parameter, to yield a shrinkage parameter; (v) configure the WFM to automatically schedule staffing for the interval-time based on the yielded shrinkage parameter; and (vi) after all time-intervals in each working-shift has been scheduled staffing, storing the optimized working-shift in a database that is associated to the WFM application and configure the WFM application to automatically trigger a notification to each agent that has been scheduled the working-shift.

### BRIEF DESCRIPTION OF THE DRAWINGS

FIGS. 1A-1C schematically illustrate a high-level diagram of a system for optimizing staffing of a working-shift during a date range by predicting adherence parameter of the working-shift based on a Scheduling Unit (SU), in accordance with some embodiments of the present disclosure;

FIGS. 2A-2B are a high-level workflow of a computerized-method for optimizing staffing of a working-shift during a date range by predicting adherence parameter of the working-shift based on an SU, in accordance with some embodiments of the present disclosure;

FIG. 3 is a high-level workflow of forecast adherence engine for SU and activity code, in accordance with some embodiments of the present disclosure;

FIG. 4 schematically illustrates a high-level diagram of time-off and coaching aggregation engine, in accordance with some embodiments of the present disclosure;

FIG. 5 is a simulation of shrinkage calculation, in accordance with some embodiments of the present disclosure;

FIG. 6 is a simulation of the staffing output with and without automated shrinkage, in accordance with some embodiments of the present disclosure; and

FIGS. 7A-7E are screenshots of a User Interface (UI) that is associated to a Workforce Management (WFM) application, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Currently all Workforce Management (WFM) adherence systems are reactive and there is no feedback system to improve staffing using adherence Key Performance Indicator (KPI). Current WFM systems are reactive as to adherence and compute it in real time or after the agent has performed the activity.

The shrinkage factor that is used in the staffing computation is calculated manually which results in errors and low accuracy of the generated staffing. Furthermore, another important KPI i.e., adherence is not used in the calculation of the shrinkage factor, as the shrinkage parameter calculation during staffing, considers absence or trainings but not the adherence factor.

Moreover, the shrinkage is calculated manually for many Scheduling Units (SU) s and for many time-intervals during a working-shift, e.g., 15 min which results in lengthy calculations. The manual process leads to bad experience for WFM managers. Out of adherence scenarios are known after they happen leading to high ASA and bad customer experience and are not included in the calculation of the shrinkage parameter.

Accordingly, there is a need for a technical solution for automating the shrinkage calculation based on existing data in the system for optimizing staffing of one or more working-shifts during a date range by predicting adherence parameter of the working-shift based on the SU.

Furthermore, there is a need for a technical solution to determine a time to schedule an activity during a working-shift to achieve maximum adherence and to determine the accuracy of the schedule from the adherence perspective.

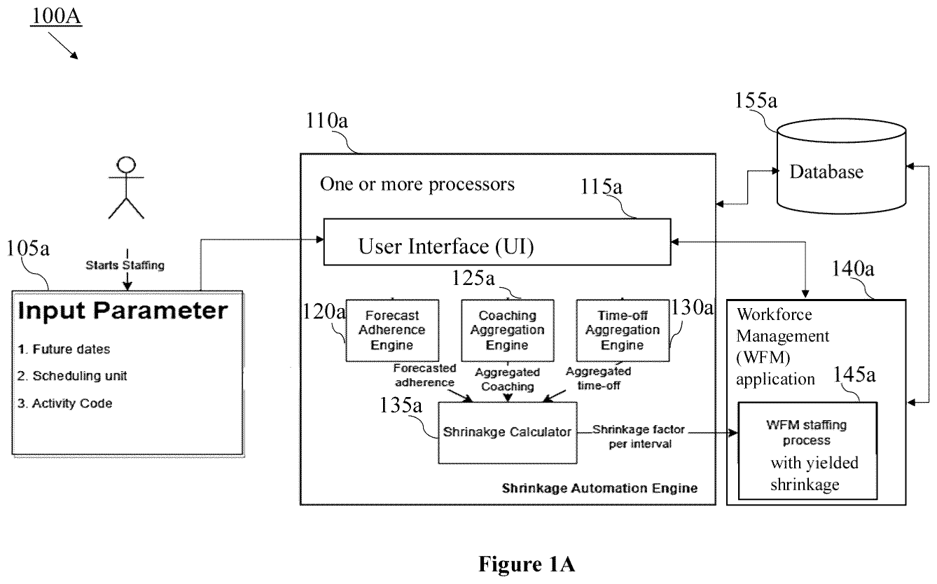

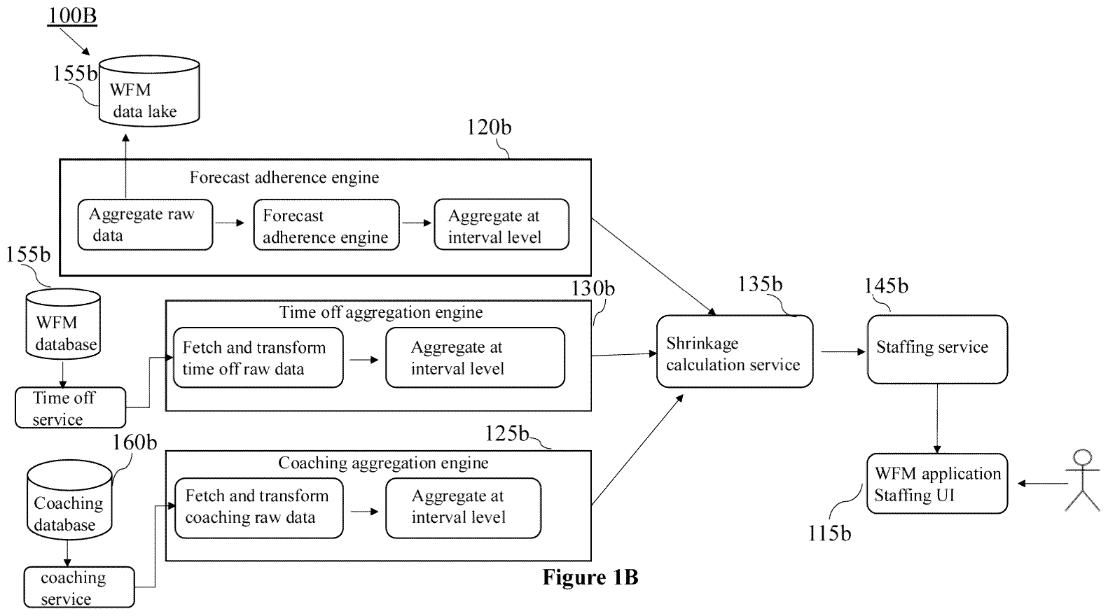

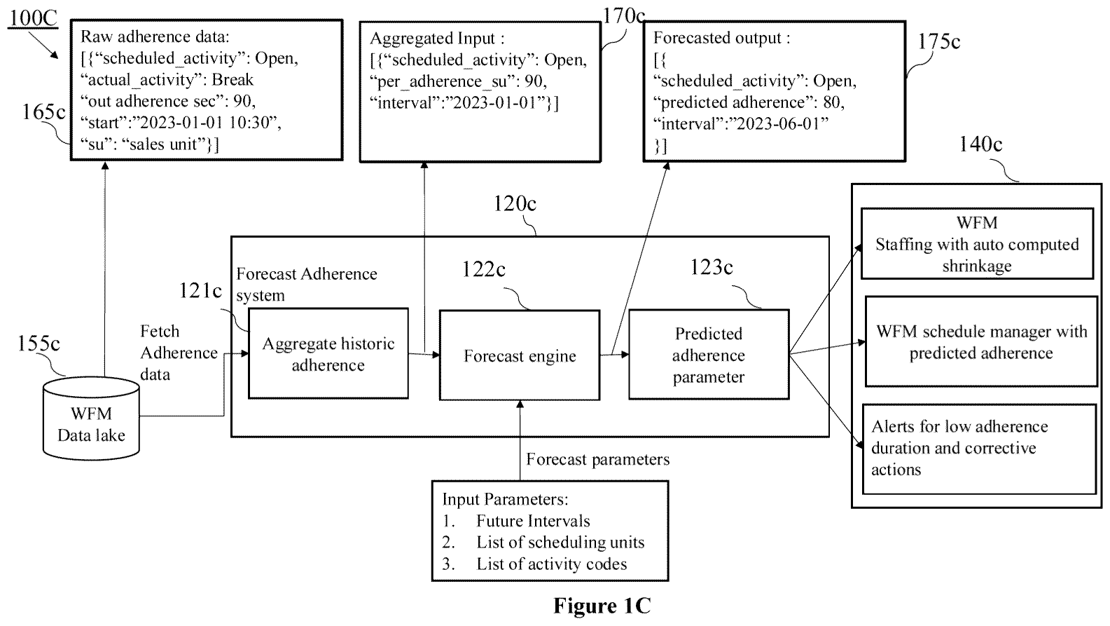

FIG. 1A schematically illustrates a high-level diagram of a system 100A for optimizing staffing of a working-shift during a date range by predicting adherence parameter of the working-shift based on a Scheduling Unit (SU), in accordance with some embodiments of the present disclosure.

According to some embodiments of the present disclosure, a system, such as system 100A may automate shrinkage calculation and consider the adherence KPI in the calculation. System 100A may forecast the adherence for a future date, per activity and scheduling unit and automatically calculate the shrinkage factor using data that is present in the database 155a of the system.

According to some embodiments of the present disclosure, system 100A may use historic adherence data to identify pattern for each activity code and SU, such as sales, marketing and the like. Each SU may include a group of agents. Then, the system 100A may predict adherence by using various forecasting algorithm for future dates, SU and activity code and may automatically calculate the shrinkage factor per SU per day of week before staffing to optimize staffing of each working-shift during a date range by predicting the adherence parameter of the working-shift based on a scheduling unit.

According to some embodiments of the present disclosure, the forecasting algorithm may be any standard statistical forecasting algorithm which can be modified to use day of week strategy and forecast based on SU and activity code can be used as part of solution. The shrinkage may be calculated using multiple factors like coaching, training, leaves and forecasted adherence using a weighted mean formula.

According to some embodiments of the present disclosure, system 100A may proactively predict the adherence in contrast to currently existing reactive adherence systems. While current systems do not have provision to forecast adherence, system 100A may predict the adherence parameter based on the time duration, activity codes and scheduling units before scheduling staffing plans.

According to some embodiments of the present disclosure, system 100A may be integrated with staffing process to automate shrinkage calculation and improve staffing process efficiency, by using data that already exists in the database to automate the shrinkage calculation.

According to some embodiments of the present disclosure, even though the adherence is an agent specific KPI, system 100A is agent agnostic and predicts the adherence parameter per SU. Therefore, in contrast to existing systems, even when historic data of agent is not present or there is high churn rate, the accuracy of the predicted adherence parameter that is included in the shrinkage calculation is high.

According to some embodiments of the present disclosure, system 100A may use data from multiple sources to automatically calculate the shrinkage parameter, thus leveraging benefits of cross-suite applications, which does not exist in current systems.

According to some embodiments of the present disclosure, system 100A may use a plurality of statistical forecasting models to predict the adherence parameter for the activity code and the SU during the provided time range for each time-interval in the one or more working-shifts. The statistical forecasting models may predict the adherence parameter at day and time interval level.

According to some embodiments of the present disclosure, the statistical forecasting models may use day of week strategy to predict adherence for activity codes accurately, which does not exist in current WFM systems. The predictive adherence parameter is used to generate efficient staffing, which can be looped into scheduling to generate schedule with maximum adherence KPI.

According to some embodiments of the present disclosure, optionally, upon an addition of an activity to a schedule, system 100A may generate suggestions for time slots in the schedule, which a user, such as a WFM manager can choose from, or the activity may be automatically approve, such that adherence is maximized.

According to some embodiments of the present disclosure, system 100A may generate predicted adherence patterns which may be accurate even in case of high agent churn rate.

According to some embodiments of the present disclosure, system 100A may be integrated with an existing WFM application to prompt managers and supervisors about their upcoming adherence parameter trends and to provide an indication of the necessity to take corrective actions.

According to some embodiments of the present disclosure, system 100A may operate a forecast adherence engine 120a that may retrieve from the database 155a, historic working-shifts during a preconfigured period for the SU and the activity code and then aggregate adherence data of each historic interval-time in the retrieved historic working-shifts. Database 155a may be associate to the WFM application and may store information on adherence, coaching and time-off historical data.

According to some embodiments of the present disclosure, the forecast adherence engine 120a may further calculate an average of adherence percentage of each historic time-interval to yield an actual adherence percentage and apply a plurality of statistical algorithms on each historic interval-time in the retrieved working-shifts to yield a predicted history-adherence parameter.

According to some embodiments of the present disclosure, a Mean Absolute Percentage Error (MAPE) for each statistical algorithm may be calculated according to formula I:

MAPE=(1/number of interval-times)*Σ[(actual adherence percentage−predicted history-adherence parameter)/actual adherence percentage]*100 (I)
whereby:
number of interval-times is a number of historic interval-times in the retrieved historic working-shifts,
actual adherence percentage is the yielded actual adherence percentage,
predicted history-adherence parameter the yielded predicted history-adherence parameter of the statistical algorithm.

According to some embodiments of the present disclosure, a statistical algorithm, e.g., statistic forecasting model may be selected from the plurality of statistical algorithms based on the calculated MAPE to apply the selected statistical algorithm on the interval-time to yield the predicted adherence parameter. For example, the plurality of statistical algorithms may include at least one of: (i) Box Jenkins Arima model; (ii) Exponential smoothing model; and (iii) Curve fitting model.

According to some embodiments of the present disclosure, system 100A may be expanded to include more factors, thus making it scalable and the staffing process may be easily re-generated considering real-time schedule such as time-off and coaching changes.

According to some embodiments of the present disclosure, an accurate staffing may be generated with the automated shrinkage parameter which considers the adherence factor and schedules may be adjusted in advance to achieve maximum adherence. Adherence trends may be tracked via intraday management, i.e., the process of monitoring and managing workloads, employee schedules, and resources throughout the day in real-time, at a granular level, where conditions can change rapidly. Thus, responding to unexpected events, such as sudden changes in interactions volume, by adjusting schedules and resources to maintain efficiency and service levels.

According to some embodiments of the present disclosure, system 100A may proactively display upcoming out of adherence duration to users, such as supervisors and managers to better manage adherence, Average Speed of Answer (ASA) and customer experience.

According to some embodiments of the present disclosure, the implementation of system 100A may result in an efficient shrinkage and staffing calculation based on business centric data, increased efficiency and adherence of the schedules, improved user experience and easy tracking of adherence goals.

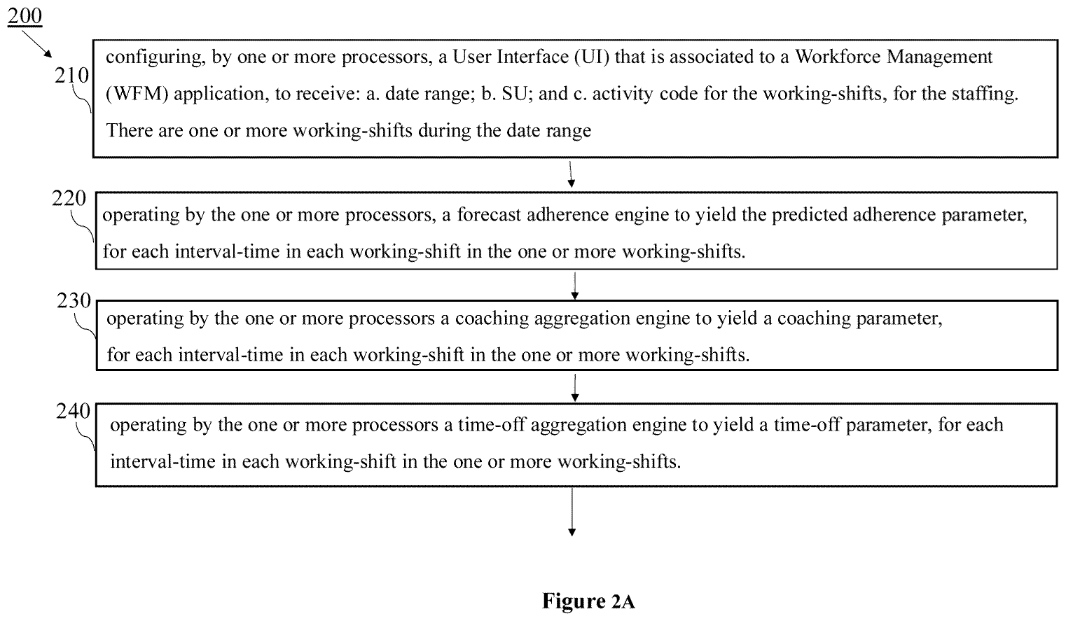

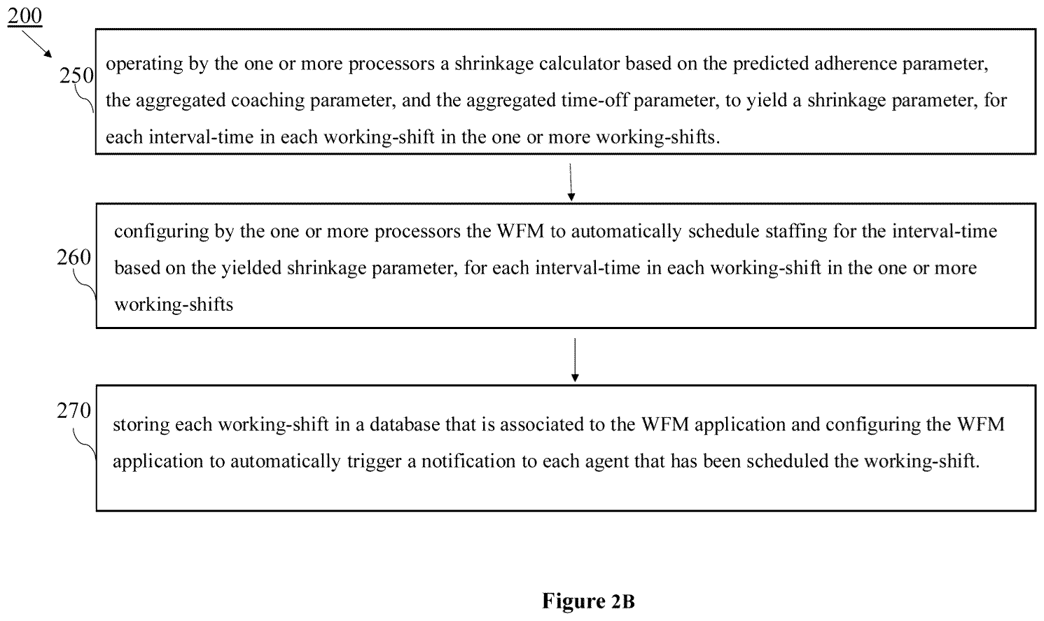

According to some embodiments of the present disclosure, system 100A may implement a computerized method, such as computerized-method 200 in FIG. 2 for optimizing staffing of one or more working-shifts during a date range by predicting adherence parameter of the working-shift based on a Scheduling Unit (SU).

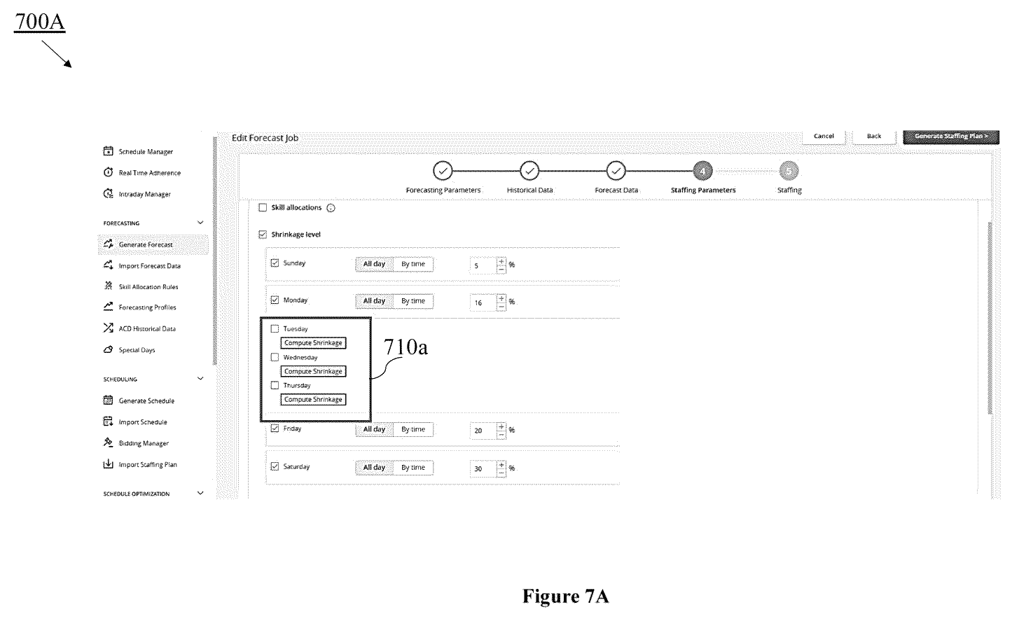

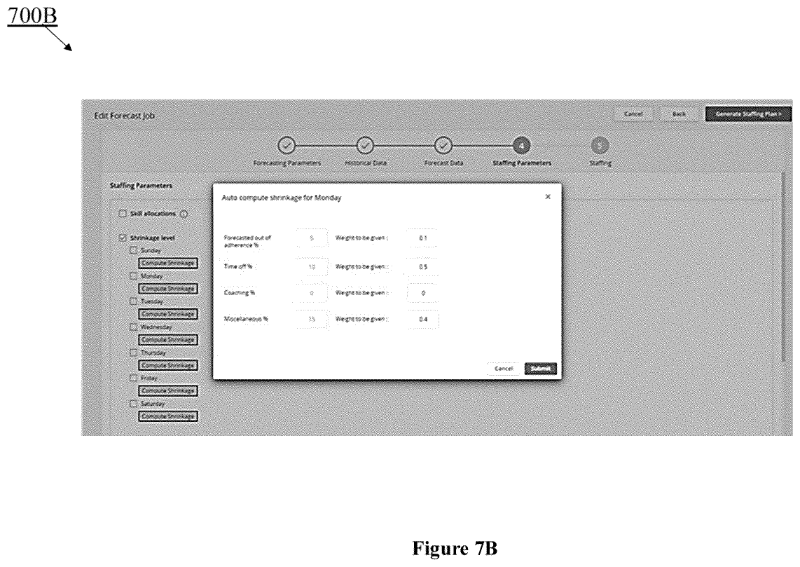

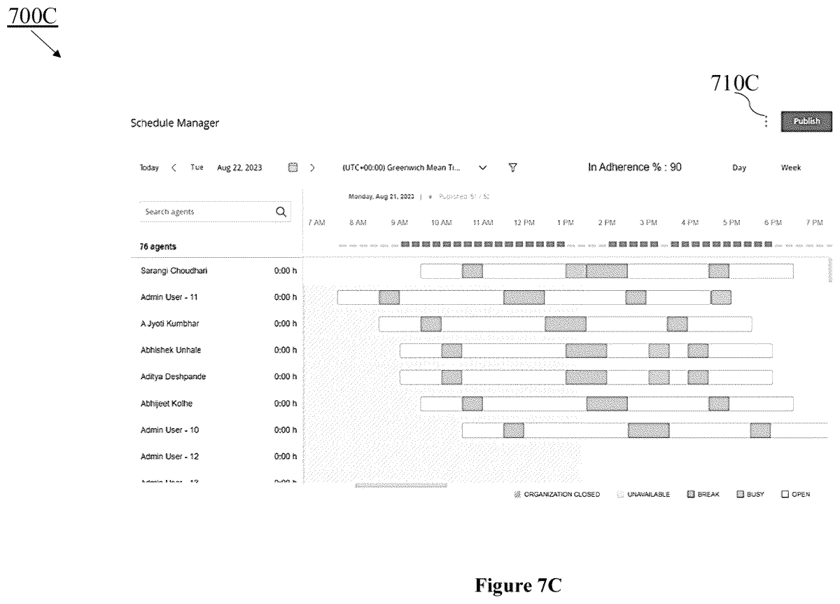

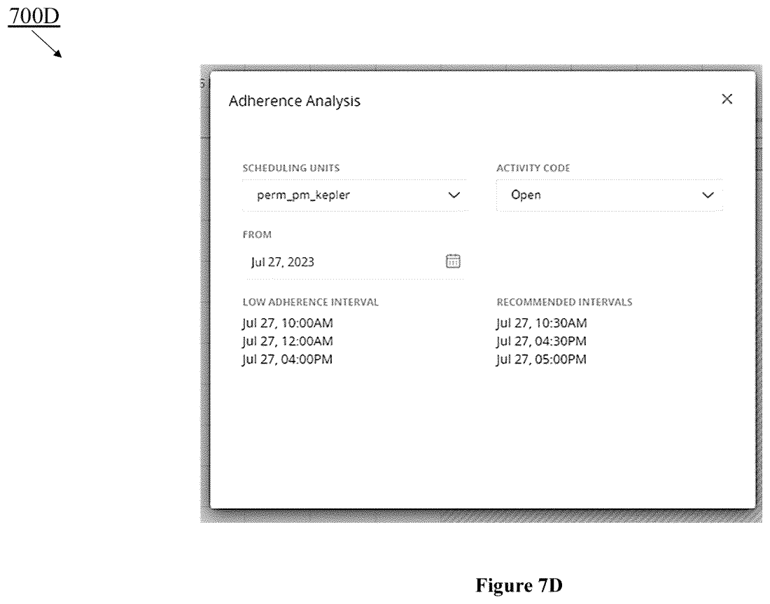

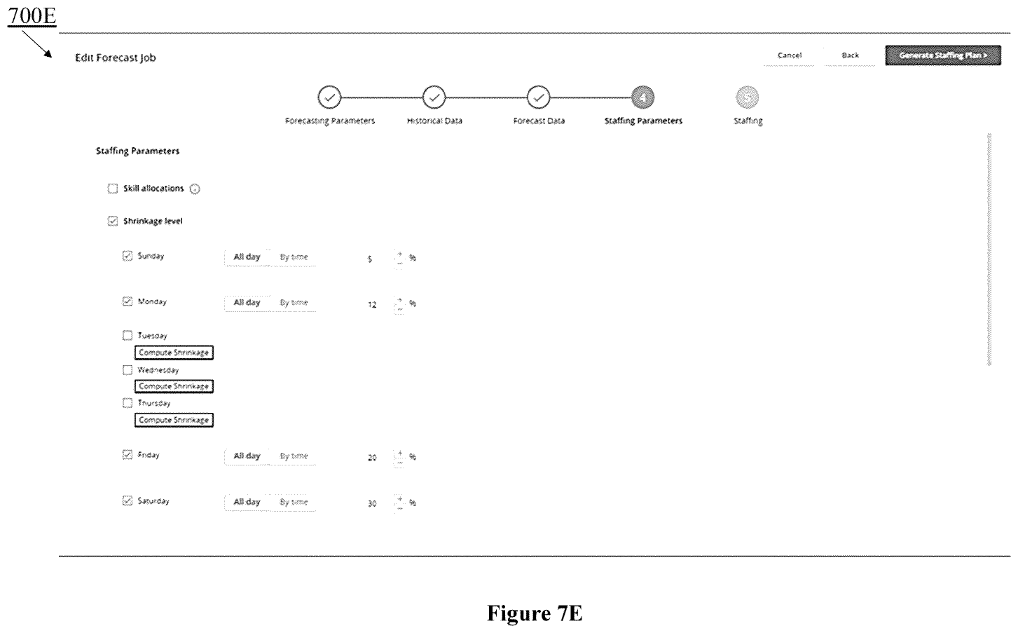

According to some embodiments of the present disclosure, one or more processors 110a may configure a User Interface 115a, such as UI 700E in FIG. 7E, that is associated to a Workforce Management (WFM) application 140a, to receive input parameters 105a, such as future dates, an SU and an activity code, e.g.: a. date range; b. SU; and c. activity code for the working-shifts, for the staffing process. There may be one or more working-shifts during the received date range.

According to some embodiments of the present disclosure, for each interval-time in each working-shift in the one or more working-shifts operating by the one or more processors 110: a forecast adherence engine 120a to yield the predicted adherence parameter, a coaching aggregation engine 125a to yield a coaching parameter, and a time-off aggregation engine 130a to yield a time-off parameter. Then, operating by the one or more processors 110a, a shrinkage calculator 135a based on the predicted adherence parameter, the aggregated coaching parameter, and the aggregated time-off parameter, to yield a shrinkage parameter per each time-interval in each working-shift.

According to some embodiments of the present disclosure, the WFM 140a may be configured by the one or more processors 110a to automatically schedule staffing for each interval-time, based on the yielded shrinkage parameter by the WFM staffing process with the yielded shrinkage 145a to maximize adherence parameter during the time-interval.

According to some embodiments of the present disclosure, after all the time-intervals in each working-shift has been scheduled staffing, the working-shift may be stored in the database 155a that is associated to the WFM application 140a and the WFM application may be configured to automatically trigger a notification to each agent that has been scheduled the working-shift.

According to some embodiments of the present disclosure, the shrinkage automation engine, e.g., shrinkage calculator 135a to calculate shrinkage may use multiple factors, such as adherence, time-off and coaching. Each parameter may be retrieved from a source by an aggregation engine. The function of the aggregation engine is to fetch the raw data from the source, transform and aggregate it at time-interval level, such that is it may be used for the shrinkage parameter calculation. The shrinkage calculator 135a may be implemented by a hosted java service.

According to some embodiments of the present disclosure, optionally, the shrinkage may be displayed via the UI 115a of the WFM application 140a.

According to some embodiments of the present disclosure, the coaching aggregation engine 125a may retrieve from the database 155a coaching data that is related to the SU for the interval-time; and then calculate the average of coaching time during the interval-time to yield the coaching parameter. The calculating of the average of coaching time during the interval-time may be according to formula II:

average of coaching time=total coaching duration*100/total duration, (I)
whereby:
the total coaching duration is a sum of coaching duration during the interval-time of each agent
that is related to the received SU, and
the total duration is the number of agents that relate to the SU in the interval-time.

According to some embodiments of the present disclosure, the time-off aggregation engine 130a may retrieve from the database 155a time-off data that is related to the SU for the interval-time; and then calculate the average of time-off during the interval-time to yield the time-off parameter. The calculating of the average time-off during the interval-time may be according to formula III:

average time-off=total time-off duration*100/total duration, (II)
whereby:
the total time-off duration is a sum of time-off duration during the interval-time of each agent that is related to the received SU, and
the total duration is the number of agents that relate to the SU in the interval-time.

According to some embodiments of the present disclosure, the shrinkage calculator may calculate a total duration of the interval-time by multiplying duration of the interval-time by a number of agents in the SU; and then may calculate the shrinkage parameter according to formula IV:

shrinkage parameter=(W1*predicted adherence parameter+W2*coaching parameter+W3*time-off parameter)/total duration*100, (III)
whereby:
the total duration is the calculated total duration,
the predicted adherence parameter is the yielded predicted adherence parameter,
the coaching parameter is the yielded coaching parameter,
the time-off parameter is the yielded time-off parameter, and
the W1, W2, W3 are weights ranging from ‘0’ to ‘1’ and a sum of all weights is ‘1’.

According to some embodiments of the present disclosure, optionally, weights for each input parameter, e.g., the W1, W2, W3, may be entered via the UI 115a that is associated to the WFM application 140a.

According to some embodiments of the present disclosure, optionally, for example, a user may click on a three dots icon, as shown by icon 710c in FIG. 7C to operate an adherence analysis based on provided input parameters and receive recommended time-intervals for an SU, activity code during a specified date, where an activity, e.g., activity code may be operated. The adherence analysis may be operated via a UI, e.g., as shown in FIG. 7D, based on input parameters, such as scheduling unit, activity code and date. After, the input parameters may be provided via UI in FIG. 7D, a module, such as forecast engine 120a, may be operated to provide and present low adherence interval and recommended time-intervals for the provided activity code for the provided SU in the provided date and onwards.

FIG. 1B schematically illustrates a high-level diagram of a system 100B for optimizing staffing of a working-shift during a date range by predicting adherence parameter of the working-shift based on a Scheduling Unit (SU), in accordance with some embodiments of the present disclosure.

According to some embodiments of the present disclosure, system 100B may include similar components as system 100A in FIG. 1A. Each engine, forecast adherence engine 120b, such as forecast adherence engine 120a in FIG. 1A, time off aggregation engine 130b, such as time off aggregation engine 130a in FIG. 1A and coaching aggregation engine 125b, coaching aggregation engine 125a in FIG. 1A, may be hosted by a cloud computing service, such as Amazon Web Services (AWS) service.

According to some embodiments of the present disclosure, these engines can be extended with increase in the factors to be considered. For example, parameters such as, duration with low skill proficiency, quality score, system maintenance time and the like.

According to some embodiments of the present disclosure, the output of each engine may be sent as an input to the shrinkage computation service 135b, such as shrinkage calculator 135a in FIG. 1A.

According to some embodiments of the present disclosure, the shrinkage calculation service 135b may aggregate the data of each factor using a weighted mean formula. For example, according to formula (IV):

shrinkage parameter=(W1*predicted adherence parameter+W2*coaching parameter+W3*time-off parameter)/total duration*100,
whereby:
the total duration is the calculated total duration,
the predicted adherence parameter is the yielded predicted adherence parameter,
the coaching parameter is the yielded coaching parameter,
the time-off parameter is the yielded time-off parameter, and
the W1, W2, W3 are weights ranging from ‘0’ to ‘1’ and a sum of all weights is ‘1’.

According to some embodiments of the present disclosure, the shrinkage calculation service 135b may calculate the shrinkage parameter at day of week and time-interval level for the provided SU and activity code. The WFM application may be configured to automatically schedule staffing for the interval-time based on the yielded shrinkage parameter by the staffing service 145b and to display the shrinkage parameter via the WFM application staffing UI 115b, such as UI 115a in FIG. 1A.

According to some embodiments of the present disclosure, the forecast adherence engine 120b may aggregate raw data from a WFM data lake, such as database 155a in FIG. 1A to operate the forecast adherence engine, which may aggregate the predicted adherence at interval level. The raw data may include historic working-shifts during a preconfigured period for the SU and the activity code. For example, raw data of last three months.

According to some embodiments of the present disclosure, the forecast adherence engine 120b may average out the historic adherence for each interval and each scheduling unit for all relevant activity codes and then calculate average adherence percentage of the historic data for each time-interval.

According to some embodiments of the present disclosure, the forecast adherence engine 120b may use last month data as test data. The interval level adherence percentage historic data may be summed up to each day.

According to some embodiments of the present disclosure, each time-interval of a working-shift may be processed by a forecasting statistical algorithm. For example, Box Jenkins Arima model, Exponential smoothening model and Curve fitting model. Then, the accuracy of each forecasting statistical algorithm may be calculated by the Mean Absolute Percentage Error (MAPE) according to general formula IV:

MAPE=(1/sample size)×Σ[(|actual adherence percentage−forecast adherence percentage|)/|actual adherence percentage|]×100 (IV)
whereby:
the sample size is the number of records, e.g., time-intervals,
the forecast adherence percentage is the forecasted adherence calculated by the statistical algorithm, and
the actual adherence percentage is the actual value of the adherence percentage from the test data.

According to some embodiments of the present disclosure, each forecasting statistical algorithm may operate the following operations to measure its accuracy: (i) fetching a total number of time-intervals in the test data; (ii) iterating the following operations on each time-interval in the forecasted test data: a. fetching the actual adherence percentage form the test data; b. calculating the difference between the actual adherence percentage and the forecasted adherence percentage; and c. dividing the calculated difference with the actual forecasted percentage to yield a deviation; (iii) calculating the sum of all the deviation of all time-intervals; and (iv) dividing the sum of all the deviations with the size of the test data, e.g., the number of time-intervals.

According to some embodiments of the present disclosure, the calculating of the Mean Absolute Percentage Error (MAPE) for each statistical algorithm may be operated according to formula V:

MAPE=(1/number of interval-times)*Σ[(actual adherence percentage−predicted history-adherence parameter)/actual adherence percentage]*100 (V)
whereby:
the number of interval-times is a number of historic interval-times in the retrieved historic working-shifts,
the actual adherence percentage is the yielded actual adherence percentage, and
the predicted history-adherence parameter is the yielded predicted history-adherence parameter of the statistical algorithm.

According to some embodiments of the present disclosure, the most accurate forecasting statistical algorithm's data may be selected and forecasted adherence for each time-interval may be generated.

According to some embodiments of the present disclosure, the time off aggregation engine 130b, such as time-off aggregation engine 130a in FIG. 1A, may fetch and transform time off raw data from the WFM database 155b by operating a time off service for the SU and activity code. The time-off data may be aggregated and averaged out for each time-interval of each working-shift.

According to some embodiments of the present disclosure, the coaching aggregation engine 125b, such as coaching aggregation engine 125a in FIG. 1A, may fetch and transform coaching raw data from the coaching database 160b which may be part of the WFM database 155b, by operating a coaching service for the SU and activity code. The coaching data may be aggregated and averaged out for each time-interval.

According to some embodiments of the present disclosure, the shrinkage calculation service 135b may calculate a total duration of the interval-time by multiplying duration of the interval-time by a number of agents in the SU and then calculate the shrinkage parameter according to formula IV:

shrinkage parameter=(W1*predicted adherence parameter+W2*coaching parameter+W3*time-off parameter)/total duration*100, (IV)
whereby:
the total duration is the calculated total duration,
the predicted adherence parameter is the yielded predicted adherence parameter,
the coaching parameter is the yielded coaching parameter,
the time-off parameter is the yielded time-off parameter, and
the W1, W2, W3 are weights ranging from ‘0’ to ‘1’ and a sum of all weights is ‘1’.

According to some embodiments of the present disclosure, the shrinkage parameter is a shrinkage percentage that is calculated for the time-interval and may be used to automatically schedule staffing for the interval-time based on the yielded shrinkage parameter.

FIG. 1C schematically illustrates a high-level diagram of a system 100C for optimizing staffing of a working-shift during a date range by predicting adherence parameter of the working-shift based on a Scheduling Unit (SU), in accordance with some embodiments of the present disclosure.

According to some embodiments of the present disclosure, system 100C may include similar components as system 100A in FIG. 1A and system 100B in FIG. 1B.

According to some embodiments of the present disclosure, the WFM data lake 155b may be implemented by a snowflake-based database that holds the raw data related to adherence. The raw data structure of the adherence may be, for example, data structure 165c. The forecast adherence system 120c, may include a forecast engine 122c, such as forecast adherence engine 120a in FIG. 1A, and such as forecast adherence engine 120b in FIG. 1B. The forecast adherence system 120c may fetch the raw data, from the WFM data lake 155c, and aggregate historic adherence 121c. Then, the forecast engine 122c may predict the adherence KPI.

According to some embodiments of the present disclosure, the data structure of the aggregated historic adherence may be for example, data structure 170c. The data structure of the predicted adherence parameter may be for example, data structure 175c.

According to some embodiments of the present disclosure, the input for the forecast adherence system 120c may be the raw historic adherence data of the received activity code that is stored in WFM data lake 155c. The adherence percentage for the SU and activity code may be calculated by:

In Adherence Percentage=((In adherence duration)*100)/(Scheduled time),
whereby the Scheduled time is the duration of a working-shift, e.g., 8 hours shift. A total schedule time is a sum of the duration of all the working-shifts of all agents in the input duration, e.g., start date and end date. For example, for a forecast of 7 days for 100 agents in a specified SU, the scheduled time calculation may be as follows, 7*8*100=4200.

According to some embodiments of the present disclosure, for example, the data structure of the activity code for a time-interval that is retrieved from the WFM data lake 155c may be, for example,
[{“scheduled activity”: Open,
“Actual activity”: Break
“Out adherence see”: 90,
“start”: “2023 Jan. 1 10:30”,
   “SU”: “sales unit”}]

According to some embodiments of the present disclosure, the data structure of the aggregated input, may be for example,
[{“scheduled activity”: Open,
“Scheduling unit”: “sales unit”,
“Percentage adherence SU”: 90,
“interval”: “2023 Jan. 1”}]

According to some embodiments of the present disclosure, the data structure of the forecasted adherence may be for example,
The data structure of forecasted adherence sample output is:
[{
“Scheduled activity”: Open,
“Predicted adherence”: 80,
“interval”: “2023 Jun. 1”
]}

According to some embodiments of the present disclosure, the predicted adherence parameter 123c may be forwarded to the WFM application 140c. The WFM application 140c may use the predicted adherence to automatically calculate the shrinkage parameter and operate staffing process based thereon.

According to some embodiments of the present disclosure, the predicted adherence parameter may be used by the WFM application 140c via schedule manager UI, for example, as shown in FIG. 7C, the time-intervals where the in-adherence percentage is above a preconfigured value, e.g., 90%

According to some embodiments of the present disclosure, the WFM application 140c may display adherence analysis for an SU and the activity code from a specified date via a UI, for low adherence time-interval as well as recommended intervals to operate an activity because the in-adherence percentage is above a preconfigured value, as shown, for example, in FIG. 7D.

According to some embodiments of the present disclosure, the aggregated in-adherence percentage is forecasted for each time-interval and at least 3 months of historic data is needed for an accurate prediction.

According to some embodiments of the present disclosure, system 100C may be implemented in any Server-side rending (SSR) language, like Java or Python. The forecast adherence system 120c groups the historic adherence data by each day of the week and then sends it to the forecast engine 122c. The forecast engine 122c may use the statistical models like Box Jenkins Arima, Exponential Smoothening and Curve Fitting by running the historic data through these models and finding the best model, i.e., most accurate model to predict the in-adherence percentage for each activity code for the SU for the time-interval.

According to some embodiments of the present disclosure,

FIGS. 2A-2B are a high-level workflow of a computerized-method 200 for optimizing staffing of a working-shift during a date range by predicting adherence parameter of the working-shift based on an SU, in accordance with some embodiments of the present disclosure.

According to some embodiments of the present disclosure, operation 210 comprising configuring, by one or more processors, a User Interface (UI) that is associated to a Workforce Management (WFM) application, to receive: a. date range; b. SU; and c. activity code for the working-shifts, for the staffing. There are one or more working-shifts during the date range.

According to some embodiments of the present disclosure, operation 220 comprising operating by the one or more processors, a forecast adherence engine to yield the predicted adherence parameter, for each interval-time in each working-shift in the one or more working-shifts.

According to some embodiments of the present disclosure, operation 230 comprising operating by the one or more processors a coaching aggregation engine to yield a coaching parameter, for each interval-time in each working-shift in the one or more working-shifts.

According to some embodiments of the present disclosure, operation 240 comprising operating by the one or more processors a time-off aggregation engine to yield a time-off parameter, for each interval-time in each working-shift in the one or more working-shifts.

According to some embodiments of the present disclosure, operation 250 comprising operating by the one or more processors a shrinkage calculator based on the predicted adherence parameter, the aggregated coaching parameter, and the aggregated time-off parameter, to yield a shrinkage parameter, for each interval-time in each working-shift in the one or more working-shifts.

According to some embodiments of the present disclosure, operation 260 comprising configuring by the one or more processors the WFM to automatically schedule staffing for the interval-time based on the yielded shrinkage parameter, for each interval-time in each working-shift in the one or more working-shifts.

According to some embodiments of the present disclosure, operation 270 comprising storing each working-shift in a database that is associated to the WFM application and configuring the WFM application to automatically trigger a notification to each agent that has been scheduled the working-shift.

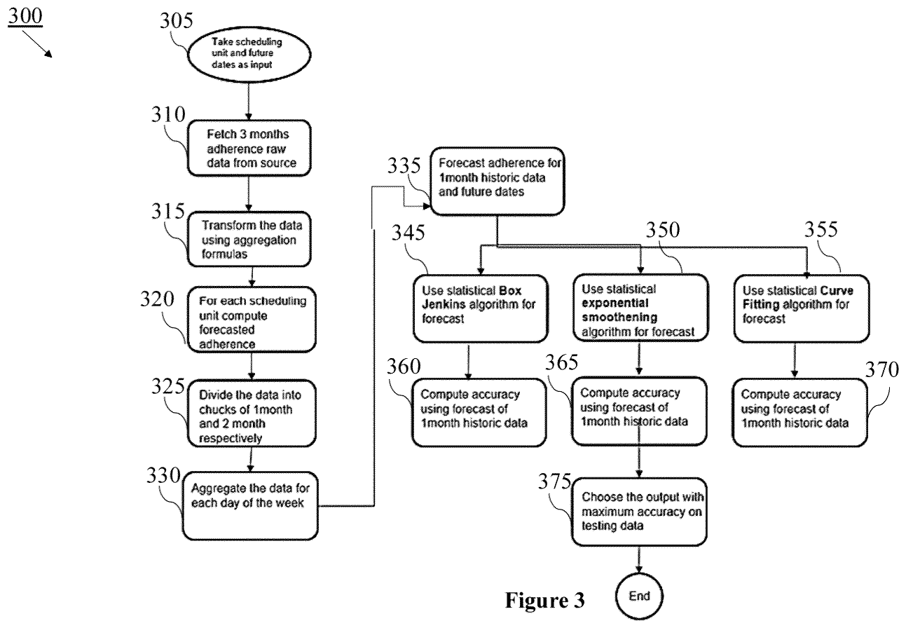

FIG. 3 is a high-level workflow of forecast adherence engine 300 for SU and activity code, in accordance with some embodiments of the present disclosure.

According to some embodiments of the present disclosure, the forecast adherence engine 300, such as forecast adherence engine 120a in FIG. 1A, and such as forecast adherence engine 120b in FIG. 1B, and such as forecast engine 122c in FIG. 1C, may be implemented as follows.

According to some embodiments of the present disclosure, forecast adherence engine 300 may take scheduling unit and future dates as input 305 and then fetch 3 months adherence raw data from source 310. Transform the data using aggregation formulas 315 such as the formula for calculating in adherence percentage. For each scheduling unit compute forecast adherence 320 and then, divide the data into chunks of 1 month and 2 months respectively 325.

According to some embodiments of the present disclosure, the forecast adherence engine 300 may aggregate the data for each day of the week. Operate forecast adherence for 1-month historic data and future dates 335 and provide it to the plurality of statistical algorithms comprising at least one of: (i) Box Jenkins Arima model; (ii) Exponential smoothing model; and (iii) Curve fitting model.

According to some embodiments of the present disclosure, use statistical Box Jenkins Arima algorithm for forecast 345 and compute accuracy using forecast of 1-month historic data 360, use statistical Exponential smoothing algorithm 350 for forecast compute accuracy using forecast of 1-month historic data 365 and use statistical Curve fitting algorithm for forecast and compute accuracy using forecast of 1-month historic data 370.

According to some embodiments of the present disclosure, choose the output from 360, 365, 370 with maximum accuracy on the testing data 375.

According to some embodiments of the present disclosure, for example, when the historic period that is used is for example, of 3 months, January to March, the data from January to March is used to predict adherence of the forecast period selected and March's 1-month historical data is used to check the accuracy of the predicted adherence.

According to some embodiments of the present disclosure, before aggregating the historical data for each day of the week, the adherence percentage of the entire day is summed up.

According to some embodiments of the present disclosure, a map of each day of the week is created, such that a grouping of date wise data is operated at a day of the week level.

According to some embodiments of the present disclosure, the created map is fed into the forecast engine 300 to predict adherence percentage of each day.

According to some embodiments of the present disclosure, the forecast engine 300 may implement several statistical models to predict the adherence percentage of each day. Since, the adherence pattern for each SU and day of week may vary for each combination of SU and activity code, different statistical algorithms may provide different results based on the pattern in the data and the math that is involved in prediction. Therefore, to ensure that there is minimum deviation in prediction and actual, accuracy is computed in each calculation.

According to some embodiments of the present disclosure, the raw data at time-interval level is aggregated to the day of week level and then the algorithms are executed. After the results are generated, it is transformed from day of week to time-interval level again.

According to some embodiments of the present disclosure, the Box Jenkins Arima methodology uses differences between data points to determine outcomes. The methodology allows the model to identify trends using auto regression, moving averages, and seasonal differencing to generate forecasts.

According to some embodiments of the present disclosure, the Exponential smoothening in the simple moving average, the past observations are weighted equally, exponential functions are used to assign exponentially decreasing weights over time. It is making some determination based on prior assumptions by the user, such as seasonality. Exponential smoothing is generally used for the analysis of time-series data.

According to some embodiments of the present disclosure, the Curve fitting algorithm: using a statistical technique, least squares that is used to find a curve such that the sum of squares of the residuals is minimum, i.e., best-fitting curve to a given set of data by minimizing the sum of the squares of the residuals. The residual, refer to the difference between the observed sample and the estimation from the fitted curve. It may be used both for linear and non-linear relationships.

According to some embodiments of the present disclosure, once the adherence is predicted using the above-mentioned statistical models, accuracy of each model may be calculated using Mean Absolute Percentage Error (MAPE) for the test data.

MAPE=(1/sample size)×Σ[(|actual adherence−forecast adherence|)/|actual adherence|]×100
whereby,
the sample size is the number of time-intervals,
the forecast adherence is the forecast adherence provided by the forecast statistical algorithm, and
the actual adherence is the actual adherence value from test data.

According to some embodiments of the present disclosure, the adherence parameter may be aggregated at time-interval and SU level and used to calculate shrinkage factor by averaging it according to:

Shrinkage adherence factor=(100−Avg(In adherence percentage)).

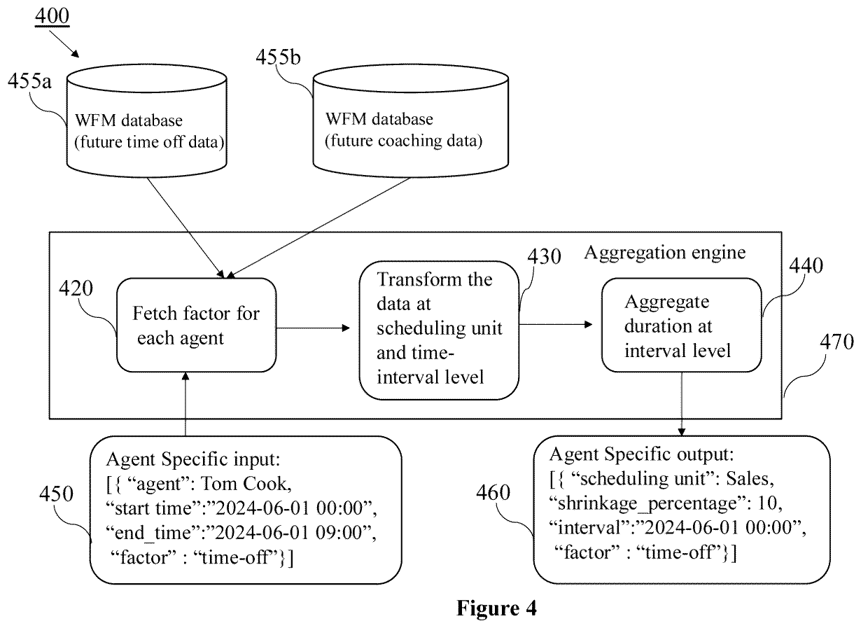

FIG. 4 schematically illustrates a high-level diagram 400 of time-off and coaching aggregation engine, in accordance with some embodiments of the present disclosure.

According to some embodiments of the present disclosure, an aggregation engine, such as aggregation engine 470 be implemented to aggregate approved time-off and coaching schedules of the agent. It may receive agent specific data and may aggregate it to interval specific data and for each SU.

According to some embodiments of the present disclosure, the aggregation engine 470 for the parameters time off and coaching may operate the following data transformation. Fetch factor for each agent 420 that is in the received SU and activity code, by fetching raw data related to the factor from the WFM databases 455a and 455b, such as database 155a in FIG. 1A. Data from WFM database 455a of future time off data for directly using the future time-off information and WFM database 455b of future coaching data may be transformed by transform the data at scheduling unit and time-interval level 430, thus, leveraging available data to predict staffing for future time-intervals.

According to some embodiments of the present disclosure, for example, the data structure of an agent specific input 450 may be:
Agent Specific input:
[{“agent”: Tom Cook,
“start time”: “2024 Jun. 1 00:00”,
“end_time”: “2024 Jun. 1 09:00”,
“factor”: “time-off”}]

According to some embodiments of the present disclosure, then, aggregate the data at interval level to compute shrinkage percentage 440.

According to some embodiments of the present disclosure, the total shrinkage duration per each factor may be calculated for each SU and time-interval. A total shrinkage duration may be calculated by:

Total Shrinkage Duration=Sum (factor value) and then shrinkage percentage may be calculated per interval, per scheduling unit by:

Total duration=Interval duration*No. of agent, and

Shrinkage percentage=Total shrinkage duration/Total duration*100.

According to some embodiments of the present disclosure, the aggregated parameters are the output of forecast adherence engine, time-off and coaching aggregation engine. The total shrinkage percentage will be computed considering all the factors where the weight of each factor can be decided as per the business requirement. The system, such as system 100A in FIG. 1A, may be expanded to include more factors, as per the business' needs.

Shrinkage %=W1*F1+W2*F2+W3*F3 . . . +Wn*Fn,
whereby:
Wi is a weight ranging from ‘0’ to ‘1’ and Sum (Wi)=‘1’,
Fi is a value of the shrinkage factor in percent.
This shrinkage percentage is calculated for each day of the week and used for efficient staffing requirement generation by a system, such as system 100A in FIG. 1, such as system 100B in system 100B and such as system 100C in FIG. 1C.

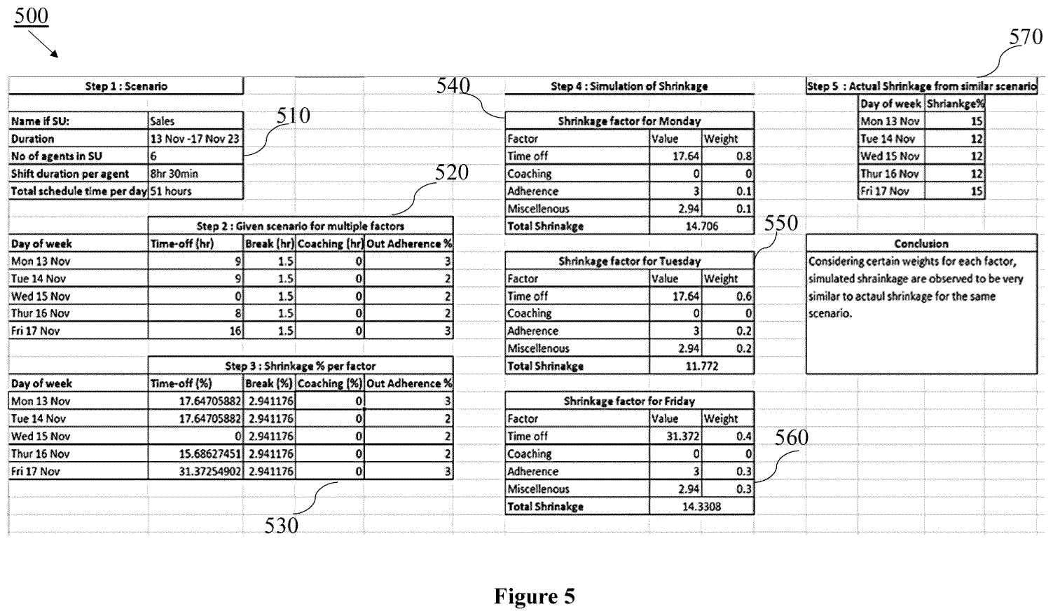

FIG. 5 is a simulation 500 of shrinkage calculation, in accordance with some embodiments of the present disclosure.

According to some embodiments of the present disclosure, table 510 shows a scenario data of scheduling unit “Sales” with six agents and a total schedule time per day of 6*8.5=51 hours. Table 520 shows the multiple factors, for the scenario of table 510. Out of adherence and in adherence are complimentary KPIs. Out of adherence %=100-in adherence %. Each day of the week's data, in the provided date range, with respect to time off, schedules, coaching and out of adherence. Table 530 shows the shrinkage percentage derived from the previous data processing for each day of the week. The hours from each category in table 520 may be converted into percentage by dividing with total schedule time i.e., 51 hours, as per the following formula:

Shrinkage %=W1*F1+W2*F2+W3*F3 . . . +Wn*Fn,
whereby:
Wi is a weight ranging from ‘0’ to ‘1’ and Sum (Wi)=‘1’, and
Fi is a value of the shrinkage factor as percentage.

According to some embodiments of the present disclosure, the shrinkage percentage is calculated considering each factor and assigned respective weights, for each day of the week. The actual shrinkage given by a forecaster, as shown in table 570, may be compared with the auto computed shrinkage, as shown in table 570, where 3 days are considered: the actual shrinkage on Monday was 15% and the predicted shrinkage was 14.7% as shown in table 540. The actual shrinkage on Tuesday was 12% and the predicted shrinkage was 11.77%, as shown in table 550. The actual shrinkage on Friday was 15% and the predicted shrinkage was 14.33%, as shown in table 560.

According to some embodiments of the present disclosure, considering the assigned weights for each factor, the simulated shrinkage parameters are observed to be close to the actual shrinkage value for the same scenario.

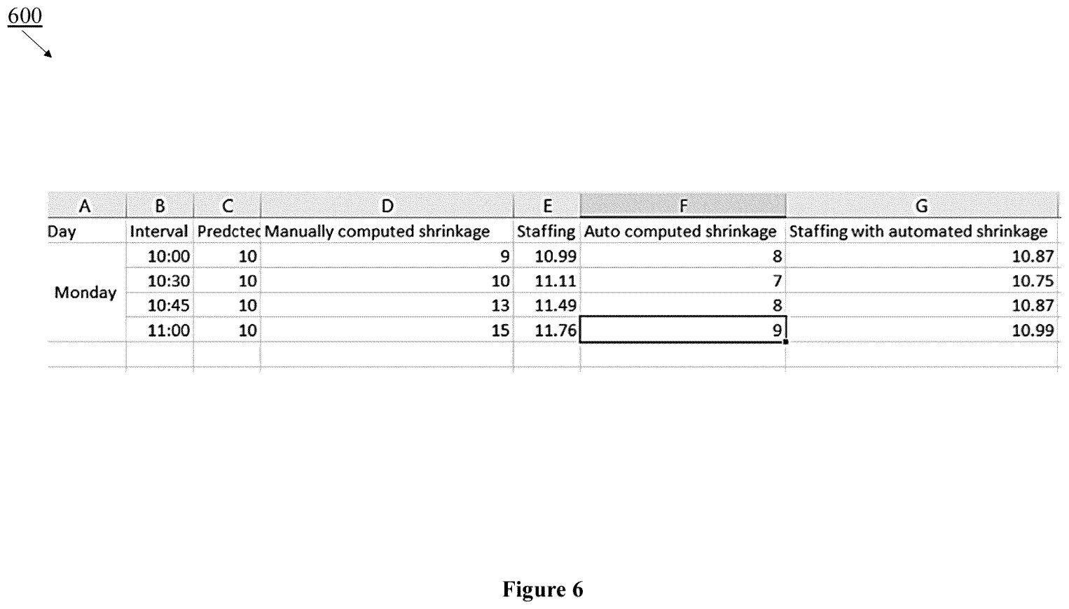

FIG. 6 is a simulation 600 of the staffing output with and without automated shrinkage, in accordance with some embodiments of the present disclosure.

According to some embodiments of the present disclosure, simulation 600 shows staffing numbers for manually entered shrinkage parameter by a user and staffing numbers for automatically calculated shrinkage parameter, for example by a system, such as system 100A in FIG. 1A and such as system 100B in FIG. 1B and such as system 100C in FIG. 1C, per time-interval.

FIG. 7A is a screenshot of a User Interface (UI) 700A that is associated to a Workforce Management (WFM) application, in accordance with some embodiments of the present disclosure.

According to some embodiments of the present disclosure, UI 700A is an example of a UI to manually enter a shrinkage percentage for each day of the week with an additional icon, such as “Compute shrinkage” buttons 710a in UI 700A for Tuesday, Wednesday, and Thursday to alternatively automatically calculating the shrinkage percentage by operating the automatic calculation of shrinkage percentage by the operation of system 100A in FIG. 1A, e.g., as shown in UI 700B in FIG. 7B.

FIG. 7B is a screenshot of a User Interface (UI) 700B that is associated to a Workforce Management (WFM) application, in accordance with some embodiments of the present disclosure.

According to some embodiments of the present disclosure, UI 700B presents the calculated predicted adherence parameter, coaching parameter, and time-off parameter for a specified day during staffing process via the WFM application, by a system, such as system 100A, such as system 100B and such as system 100C, after a user clicked on an icon in UI 700A in FIG. 7A, such as one of the “Compute Shrinkage” icons 710a to automatically calculate the shrinkage parameter for that day with an option to assign weights to each parameter, for example as shown in FIG. 7B.

According to some embodiments of the present disclosure, a popup window may be displayed, where the required weights for each parameter may be added to automatically calculate the shrinkage parameter, i.e., shrinkage percentage.

FIG. 7E is a screenshot of a User Interface (UI) 700E that is associated to a Workforce Management (WFM) application, in accordance with some embodiments of the present disclosure.

According to some embodiments of the present disclosure, UI 700E may be used to display the output of the automatically calculated shrinkage. UI 700E shows the auto computed shrinkage for Sunday is 5% based on the weighted given by a user, for example via UI 700B. The shrinkage that is auto computed is used in staffing generation to adjust each day's staffing based on the predicted shrinkage. For example, in a situation where staffing requirement for one Sunday is 10 agents, with shrinkage computed to 5% on Sunday, the updated staffing for that Sunday based on the calculated shrinkage parameter would be 10.5 agents.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for optimizing staffing of a working-shift during a date range by predicting an adherence parameter of the working-shift based on a Scheduling Unit (SU), said computerized-method comprising:
(i) configuring, by one or more processors, a User Interface (UI) that is associated to a Workforce Management (WFM) application to receive: a. date range; b. SU; and c. activity code for the working-shifts, for the staffing,
wherein there are one or more working-shifts during the date range,
for each interval-time in each working-shift in the one or more working-shifts:
(ii) operating by the one or more processors, a forecast adherence engine to yield the predicted adherence parameter;
(iii) operating by the one or more processors, a coaching aggregation engine to yield a coaching parameter;
(iv) operating by the one or more processors, a time-off aggregation engine to yield a time-off parameter;
(v) operating by the one or more processors, a shrinkage calculator based on the predicted adherence parameter, the aggregated coaching parameter, and the aggregated time-off parameter, to yield a shrinkage parameter;
(vi) configuring by the one or more processors, the WFM to automatically schedule staffing for the interval-time based on the yielded shrinkage parameter; and
(vii) after all time-intervals in each working-shift has been scheduled staffing, storing the working-shift in a database that is associated to the WFM application and configuring the WFM application to automatically trigger a notification to each agent that has been scheduled the working-shift.

2. The computerized-method of claim 1, wherein the forecast adherence engine comprising:
(i) retrieving from the database historic working-shifts during a preconfigured period for the SU and the activity code;
(ii) aggregating adherence data of each historic interval-time in the retrieved historic working-shifts;
(iii) calculating an average of adherence percentage of each historic time-interval to yield an actual adherence percentage;
(iv) applying a plurality of statistical algorithms on each historic interval-time in the retrieved working-shifts to yield a predicted history-adherence parameter;
(v) calculating a Mean Absolute Percentage Error (MAPE) for each statistical algorithm;
(vi) selecting a statistical algorithm from the plurality of statistical algorithms based on the calculated MAPE; and
(vii) applying the selected statistical algorithm on the interval-time to yield the predicted adherence parameter.

3. The computerized-method of claim 2, wherein the plurality of statistical algorithms comprising at least one of: (i) Box Jenkins Arima model; (ii) Exponential smoothing model; and (iii) Curve fitting model.

4. The computerized-method of claim 1, wherein the coaching aggregation engine comprising:
(i) retrieving from the database coaching data that is related to the SU for the interval-time; and
(ii) calculating the average of coaching time during the interval-time to yield the coaching parameter,
wherein the calculating of the average of coaching time during the interval-time is according to formula I:
average of coaching time=total coaching duration*100/total duration, (I)
whereby:
the total coaching duration is a sum of coaching duration during the interval-time of each agent that is related to the received SU, and
the total duration is the number of agents that relate to the SU in the interval-time.

5. The computerized-method of claim 1, wherein the time-off aggregation engine comprising:
(i) retrieving from the database time-off data that is related to the SU for the interval-time; and
(ii) calculating the average of time-off during the interval-time to yield the time-off parameter, wherein the calculating of the average time-off during the interval-time is according to formula II:
average time-off=total time-off duration*100/total duration, (II)
whereby:
the total time-off duration is a sum of time-off duration during the interval-time of each agent that is related to the received SU, and
the total duration is the number of agents that relate to the SU in the interval-time.

6. The computerized-method of claim 1, wherein the shrinkage calculator comprising:
(i) calculating a total duration of the interval-time by multiplying duration of the interval-time by a number of agents in the SU; and
(ii) calculating the shrinkage parameter according to formula III:
shrinkage parameter=(W1*predicted adherence parameter+W2*coaching parameter+W3*time-off parameter)/total duration*100, (III)
whereby:
the total duration is the calculated total duration,
the predicted adherence parameter is the yielded predicted adherence parameter,
the coaching parameter is the yielded coaching parameter,
the time-off parameter is the yielded time-off parameter, and
the W1, W2, W3 are weights ranging from ‘0’ to ‘1’ and a sum of all weights is ‘1’.

7. The computerized-method of claim 6, wherein the computerized-method is further comprising configuring the UI that is associated the WFM application to receive the weights.

8. The computerized-method of claim 1, wherein the SU comprising a group of agents.

9. A computerized-system for optimizing staffing of a working-shift during a date range by predicting adherence parameter of the working-shift based on a Scheduling Unit (SU), said computerized-system comprising:
a database;
a memory to store the database; and
one or more processors, said one or more processors are configured to:
(i) configure a User Interface (UI) that is associated to a Workforce Management (WFM) application to receive: a. date range; b. SU; and c. activity code for the working-shifts, for the staffing,
wherein there are one or more working-shifts during the date range,
for each interval-time in each working-shift in the one or more working-shifts:
(ii) operate a forecast adherence engine to yield the predicted adherence parameter;
(iii) operate a coaching aggregation engine to yield a coaching parameter;
(iv) operate a time-off aggregation engine to yield a time-off parameter;
(v) operate a shrinkage calculator based on the predicted adherence parameter, the aggregated coaching parameter, and the aggregated time-off parameter, to yield a shrinkage parameter;
(vi) configure the WFM to automatically schedule staffing for the interval-time based on the yielded shrinkage parameter; and
(vii) after all time-intervals in each working-shift has been scheduled staffing, store the optimized working-shift in a database that is associated to the WFM application and configure the WFM application to automatically trigger a notification to each agent that has been scheduled the working-shift.
